(19) United States
(12) Patent Application Publication
(10) Pub. No.: US 2005/0257229 A1
(43) Pub. Date: Nov. 17, 2005

(54) Automated system for dispensing digital information

(75) Inventors: Felix Aponte, Rochester, NY (US); Michael J. Hosey, Spencerport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/121,967

(22) Filed: May 4, 2005

Related U.S. Application Data
(60) Provisional application No. 60/570,787, filed on May 13, 2004.

(51) Int. Cl. G06F 17/30

(52) U.S. Cl. 720/600

(57) ABSTRACT

An automated system for dispensing digital information disposed on a digital medium having a circular opening. The system includes a supply area adapted to receive a plurality of digital medium, the supply area including a spindle having a non-circular cross-sectional shape adapted to receive the plurality of digital medium through the circular opening to form a stack.

This is a 111A application of Provisional Application Ser. No. 06/570,787 filed May 13, 2004.

### FIELD OF THE INVENTION

The invention relates generally to the field of dispensing of digital information from an automated transaction machine, and in particular to the dispensing of a CD or DVD.

### BACKGROUND OF THE INVENTION

The use of CDs (compact discs) and DVDs (digital video discs) for recording and/or storing digital information is well known. Such digital information can include audio, sound, music, digital still images, video, data files, and the like.

Automated transaction machines are also well known. An example of an automated transaction machine is an automated teller machine (ATM) used for banking transactions. Such ATM are typically located in retail or service locations.

Automated transaction machines have been employed to dispense digital information disposed on CDs and/or DVDs. U.S. Pat. No. 5,949,688, incorporated herein by reference, is directed to a compact disc recorder/vending machine. U.S. Patent Application No. 2003/0040838, incorporated herein by reference, is directed to a digital media vending system for distributing digital media content. In such systems, a supply of recordable digital media (for example, CDs and DVDs) are provided and digital information is transferred to the digital media using a media writer (for example, a compact disc recording device or a digital versatile disc burner) which “burns” the digital media containing the digital information.

Accordingly, there exists a need for an apparatus and method to transport at least one recording media from the supply to the media writer so that transfer of the digital information to the digital media can occur. That is, there exists a need for an automated system for dispensing recordable digital media from a supply area.

### SUMMARY OF THE INVENTION

An object of the present invention is to provide an automated system for dispensing digital information disposed on digital recording media, for example, a CD or DVD.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided an automated system for dispensing digital information disposed on a CD or DVD.

According to another aspect of the present invention, there is provided an automated system for dispensing digital information disposed on a digital medium having a circular opening. The system comprises a supply area adapted to receive a plurality of digital medium, the supply area including a spindle having a non-circular cross-sectional shape adapted to receive the plurality of digital medium through the circular opening to form a stack.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a schematic of an automated transaction machine employed to dispense digital information disposed on recordable media.

FIG. 2 shows an exemplary recordable medium employable by the automatic transaction machine of the present invention.

FIG. 3 shows a plurality of recordable medium disposed in a stack.

FIG. 4 shows a prior art spindle.

FIG. 5 shows a spindle in accordance with the present invention.

FIG. 6 shows a perspective view of a spindle in accordance with the present invention.

FIG. 7 shows a front view of the spindle of FIG. 6

FIG. 8 shows a cross-sectional view of the spindle of FIG. 7 taken along line 8-8.

### DETAILED DESCRIPTION OF THE INVENTION

The following is a detailed description of the preferred embodiments of the invention, reference being made to the drawings in which the same reference numerals identify the same elements of structure in each of the several figures.

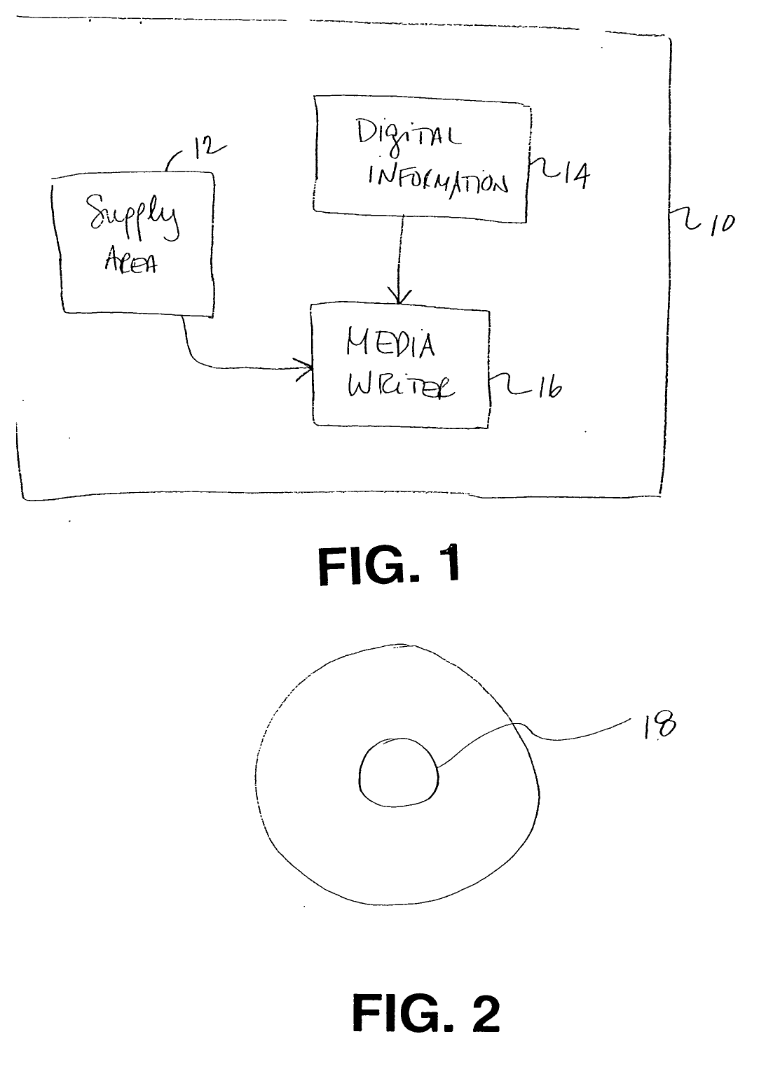

Referring to FIG. 1, there is shown a schematic of an automated transaction machine 10 employed to dispense digital information disposed on recordable media, such as CDs and/or DVDs. Machine 10 includes a supply area 12 of blank/recordable digital media (for example, CDs and DVDs), a source of digital information 14, and a media writer 16 which burns the digital media containing the digital information. Known examples of a media writer include a compact disc recording device or a digital versatile disc burner. The source can be any source of digital information, for example, a computer, the internet, a CD, a DVD, a digital file, and the like.

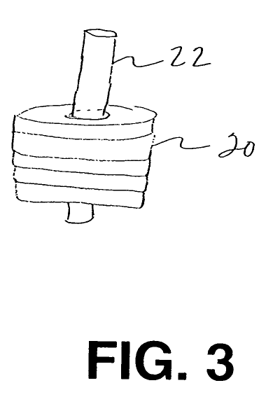

Two known types of recordable media are CDs and DVDs. As shown in FIG. 2, CDs and DVDs have a circular shape and include a circular opening 18 about which the recordable media rotates. With such a configuration, a plurality of CDs and DVDs can be formed as a stack 20 and a spindle 22 or other member can be disposed in their opening 18 to secure/hold the stack of CDs/DVDs, as shown in FIG. 3.

With the recordable media disposed as a stack, supply area 12 can supply/dispense the stacked recordable media using gravity. That is, as shown in FIG. 3, a stack/supply 20 of recordable media can be disposed in a vertical stack wherein gravity is employed to individually release/transport one recordable media from supply area 12 to media writer 16.

Applicants have found that the cross-sectional shape of spindle 22 can affect the gravity-feed of the recordable media.

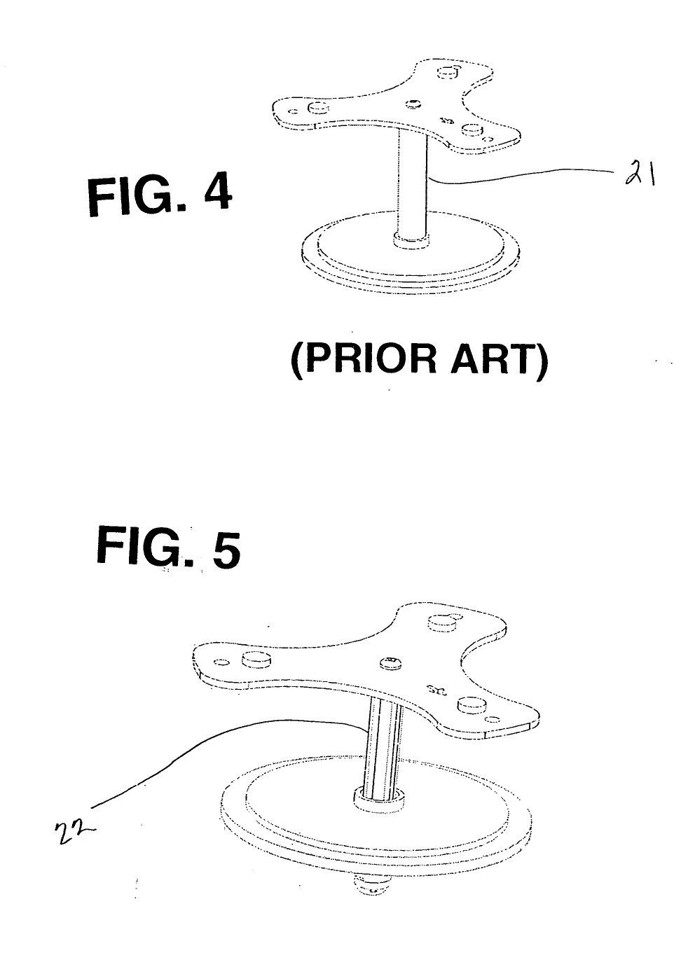

Referring to FIG. 4, in current systems, a spindle 21 has a solid outer diameter less than the diameter of opening 18. In such current spindles, the spindle may be solid or hollow.

Referring to FIGS. 5-8, in the present invention, spindle 22 has an outer diameter less than the diameter of opening 18. However, spindle 22 of the present invention does not have a solid outer diameter, that is, it does not have a circular cross-sectional shape. Rather, Applicants have determined that reducing the surface area of the spindle, without the need for reducing the outer diameter, promotes the gravity-feed of individual recording media from a supply area.

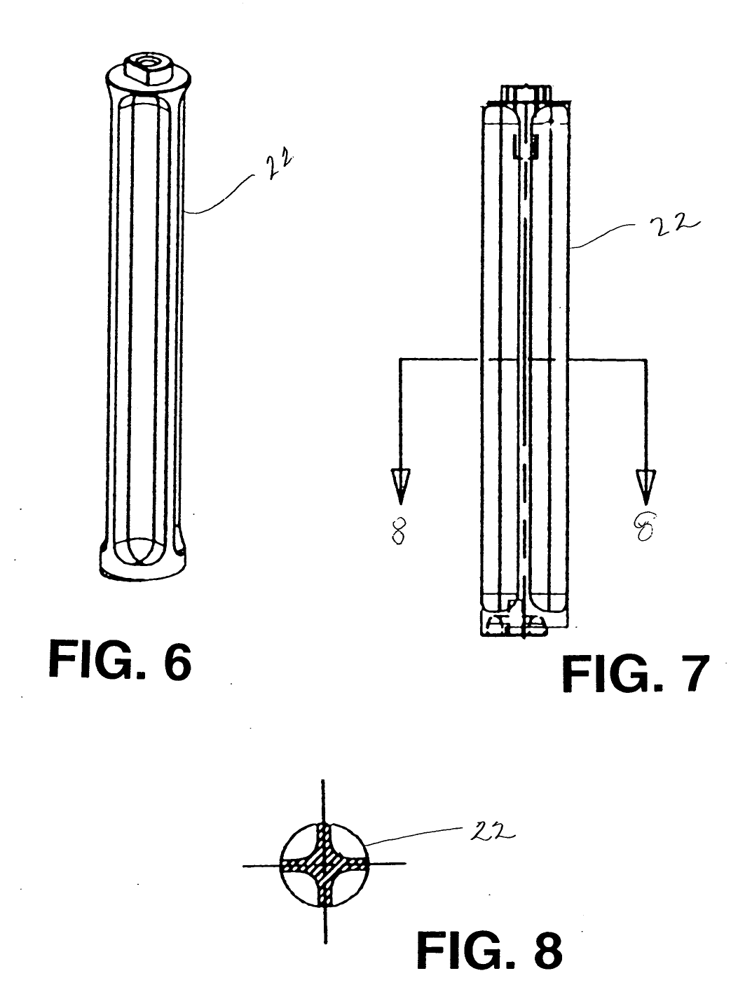

FIG. 5 shows a perspective view of a preferred configuration of spindle 22 disposed in a supply area. FIG. 6 shows another perspective view of spindle 22 of the present invention. FIG. 7 shows a front view while FIG. 8 shows a cross-sectional view of spindle 22 taken along lines 8-8 of FIG. 7. As best shown in FIG. 8, spindle 22 does not have a circular cross-sectional shape. Rather, spindle 22 has a cross-sectional shape representative of a fluted arrangement/configuration. Such an arrangement can be additionally be describe as slots, grooves or keyways within the spindle such that the spindle does not have a circular cross-sectional shape.

Spindle 22 can be comprised of any material, including a polymer or metal, or a combination thereof. Suitable metals include aluminum, steel, steel alloy, brass, iron, bronze, nickel. Further, the surface of spindle 22 can be polished and/or have a finish, such as an anodized finish.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. An automated system for dispensing digital information disposed on a digital medium having a circular opening, the system comprising:
a supply area adapted to receive a plurality of digital medium, the supply area including a spindle having a non-circular cross-sectional shape adapted to receive the plurality of digital medium through the circular opening to form a stack.
